(19) United States
(12) Patent Application Publication
(10) Pub. No.: US 2007/0169604 A1
(43) Pub. Date: Jul. 26, 2007

(54) COUNTER ROTATIONAL PACKAGE WRAPPING REMOVAL SYSTEM AND METHOD OF OPERATING THE SAME

(75) Inventor: Michael J. Brown, Baltimore, MD (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: ADCOR INDUSTRIES, INC., Baltimore, MD (US)

(21) Appl. No.: 11/626,022

(22) Filed: Jan. 23, 2007

Related U.S. Application Data
(60) Provisional application No. 60/761,116, filed on Jan. 23, 2006.
(60) Provisional application No. 60/777,834, filed on Mar. 1, 2006.

(51) Int. Cl. B26D 1/00

(52) U.S. Cl. 83/651

(57) ABSTRACT

A counter rotational package wrapping removal system and method of operation for cutting wrapping from a wrapped product has a transport for continuously moving the wrapped product in a downstream direction as the wrapping is cut. The system has a first cutter located at a distal end of a pivoting arm and preferably a second cutter located at the distal end of a second pivoting arm. Both cutters cut at least a portion of the wrapping along a leading side face of the wrapped product and each cutter cuts the wrapping at respective flanking side faces as the wrapped product move along the transport. The arms pivot in opposite directions and about respective pivoting axis orientated substantially parallel to one another and preferably perpendicular to the transport.

### CROSS REFERENCE TO RELATED APPLICATIONS

The instant application claims priority to U.S. Provisional Patent Application Ser. Nos. 60/761,116, which was filed on Jan. 23, 2006, and 60/777,834, which was filed on Mar. 1, 2006.

### FIELD OF THE INVENTION

The present invention relates generally to a package wrapping removal system and more particularly to a counter rotational package wrapping removal system with a pair of counter swinging arms.

### BACKGROUND OF THE INVENTION

Packages and products are known to be wrapped with any of a wide variety of materials including different forms of paper and various plastics. The wrapping material used is generally dictated by the needs of the package or product. The wrapping may serve to simply protect the surface of a product or to support and hold multiple items together as a single package.

One such example of multiple items being held together at least in-part by a wrapping is a plurality of beverage containers, bottles or cans. For instance, the manufacturer of a beverage may ship and/or sell their product in an allotment of twenty-four plastic bottles (i.e. a case). The bottles may be supported in a relatively inexpensive cardboard tray. For improved stacking and transportation of the cases, the bottles along with the tray are typically wrapped in a known shrink wrap material. The shrinking process of the wrap material causes the wrapping to hold tightly against the bottles and tray, thereby generally forming a structurally stable parallelepipedical body having four side faces, a top face and a bottom face.

At times it is desirable to remove the shrink wrap for repackaging the product, such as for multi-flavored packs of the product. Unfortunately, the benefits of the shrink wrap or other wrappings that contribute to structural integrity of a single body having multiple components may also create difficulties in the removal of the wrapping from the product.

### SUMMARY OF THE INVENTION

A package wrapping removal system and method of operation for cutting wrapping from a wrapped product has a transport for continuously moving the wrapped product in a downstream direction as the wrapping is cut. The system has a first cutter located at a distal end of a pivoting arm and preferably a second cutter located at the distal end of a second pivoting arm. Both cutters cut at least a portion of the wrapping along a leading side face of the wrapped product and each cutter cuts the wrapping at respective flanking side faces as the wrapped product move along the transport. The arms pivot in opposite directions and about respective pivoting axis orientated substantially parallel to one another and preferably perpendicular to the transport.

In operation, the arms of the system are cantilevered over the transport and from respective opposite directions. Each arm is preferably biased toward respective first and second normal positions and pivot away from the normal positions as the cutters abut the wrapping at the leading face. Preferably, the cutters do not abut the leading face simultaneously, and instead act in succession. In this way, a portion of the wrapping at the leading face is generally cut twice to ensure that the cut of the wrapping along the leading face of the wrapped product is continuous.

Objects, features and advantages of the present invention include a highly efficient, quick and reliable means to cut for removal a wrapping from a wrapped product in a continuous manner without changing the direction of the product.

### DESCRIPTION OF THE DRAWINGS

These and other objects, features and advantages of this invention will be apparent from the following detailed description, appended claims, and accompanying drawings in which:

FIG. 1 is a perspective forward view of a wrapping removal system embodying the present invention;

FIG. 2 is a perspective view of a wrapped product on a transport of the wrapping removal system;

FIG. 3 is a top view of the wrapped product;

FIG. 4 is a partial enlarged view of the wrapping removal system taken from circle 4 of FIG. 1;

FIG. 5 is a perspective bottom view of a swing arm of the wrapping removal system;

FIG. 6 is a perspective view of a controller of the wrapping removal system;

FIG. 7 is a enlarge partial perspective view of the wrapping removal system illustrating an adjustable stop of the swing arm;

FIG. 8 is a partial perspective view of the wrapping removal system partially illustrating a support frame of the system;

FIG. 9 is a partial perspective view of the wrapping removal system partially illustrating another portion of the support frame of the system;

FIG. 10 is a perspective upstream view of the wrapping removal system cutting the wrapping on a first wrapped product; and

FIG. 11 is a perspective upstream view of the wrapping removal system completing the cutting of the wrapping on the first wrapped product and beginning the cutting of a wrapping on a next wrapped product.

### DETAILED DESCRIPTION OF THE PREFERRED EMBODIMENTS

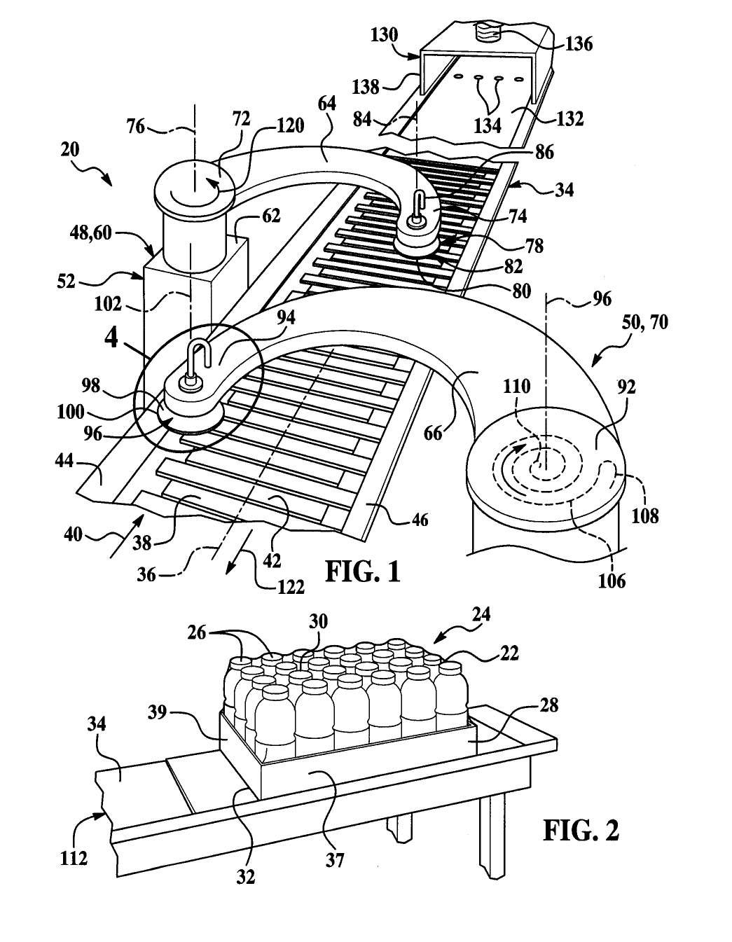

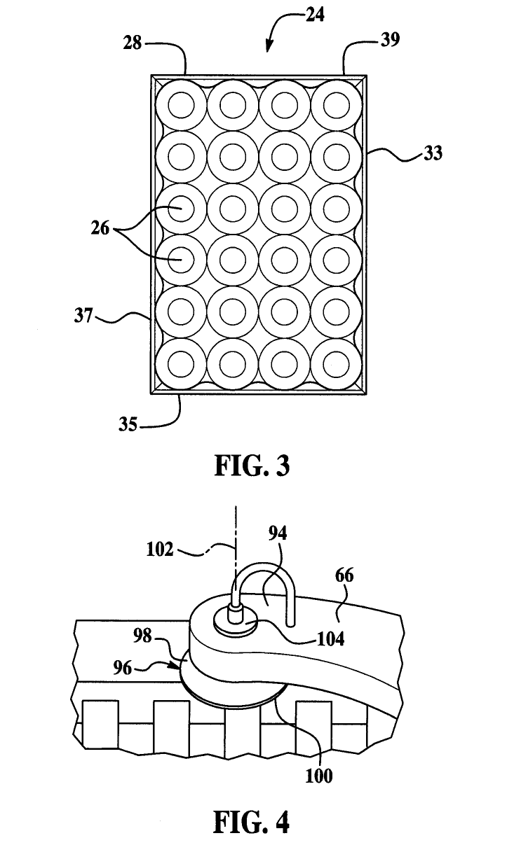

Referring to FIG. 1 of the present invention, a counter rotational package wrapping removal system 20 is illustrated and a method of operating the same shall be described. The system 20 operates to remove wrapping 22 pre-positioned or secured to a wrapped product 24. The wrapping 22 may be made of any material commonly used in the art of wrapping packages, but preferably is made of a heat sensitive material such as plastic and/or shrink wrap. As best shown in FIG. 2, the wrapped product 24 may be a plurality of beverage containers 26 located in a tray 28 typically made of cardboard. During manufacturing of the beverage, the containers 26 are placed in the tray 28 then the shrink wrap or wrapping 22 is preferably wrapped about the top 30, the bottom 32 and four side faces 33, 35, 37, 39 of the wrapped product 24.

For the sake of illustration and explanation, one of a wide variety of applications for the system 20 entails a wrapped product that includes the manufacture and placement of twenty-four of the containers 26 all filled with the same flavor of beverage. The wrapped product or case 24 of like beverages is wrapped in shrink wrap 22 so that the cases 24 are independently sturdy and do not fall apart when transported and stacked upon one another for further processing and/or sale. For retail sale purposes, it is often preferred to provide a variety of beverage flavors in a single case 24. In such instances, the system 20 is ideal for quickly and efficiently removing the shrink wrap 22 so that the containers 26 in the tray 28 of the wrapped product 24 can be resorted as a variety of flavors best suited for retail sale.

More specific to the wrapping removal system 20, the system has a transport or conveyor 34 that extends along a centerline 36 and preferably lies in a substantially horizontal imaginary plane. During operation of the system, a moving belt 38 of the transport 34 causes the wrapped product 24 to move continuously in a downstream direction 40 that generally co-extends with the centerline 36. The belt 38 has a substantially horizontal surface 42 that spans laterally between two longitudinally extending sides 44, 46 that are preferably stationary and rise above the moving belt 38 to prevent unintentional dropping or slippage of the wrapped product 24 off the transport 34. The centerline 36 is substantially centered between the sides 44, 46, and the wrapped product 24 is substantially centered on and rests upon the belt 38 as the transport 34 moves the wrapped product 24 in the downstream direction 40.

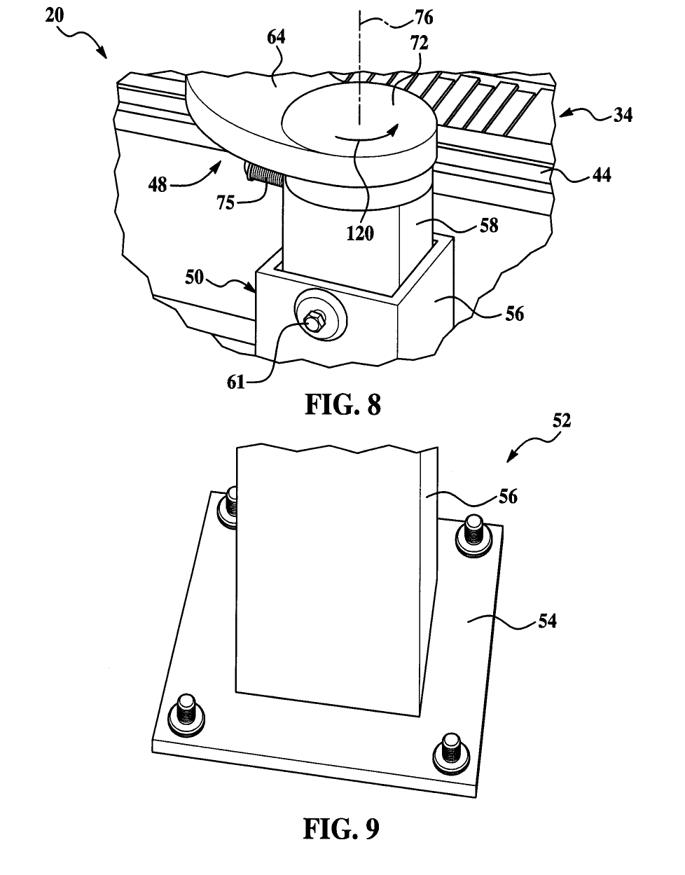

Referring to FIGS. 1, 4 and 8-9, the wrapping removal system 20 preferably has a pair of flanking cutting assemblies 48, 50 generally orientated at and rising above respective sides 44, 46 of the transport 34. The assemblies 48, 50 are preferably a mirror image of one-another. Each assembly 48, 50 has a support frame 52 that generally is an adjustably telescoping column that may rise vertically from a factory floor where a base plate 54 of the column 52 may be anchored rigidly to the floor. A stationary base member 56 preferably risings from the base plate 54. An adjustment member 58 of the column 52 secures adjustably to the base member 56 for generally adjusting the height of the column 52. A locking device 61 is carried between the members 56, 58 to secure the members to one-another once the desired height is selected. As illustrated in FIG. 8, the base and adjustment members 56, 58 are preferably square tubes with the adjustment member 58 projecting telescopically out of the base member 56. The locking device 61 is preferably a bolt threaded to a side wall of the base member 56 for extending radially inward with respect to the tubes to abut or engage the adjustment member 58 when the bolt is rotationally tightened. One skilled in the art, however, would now appreciate that the lock device 61 could be any suitable mechanism, such as a rack and pinion.

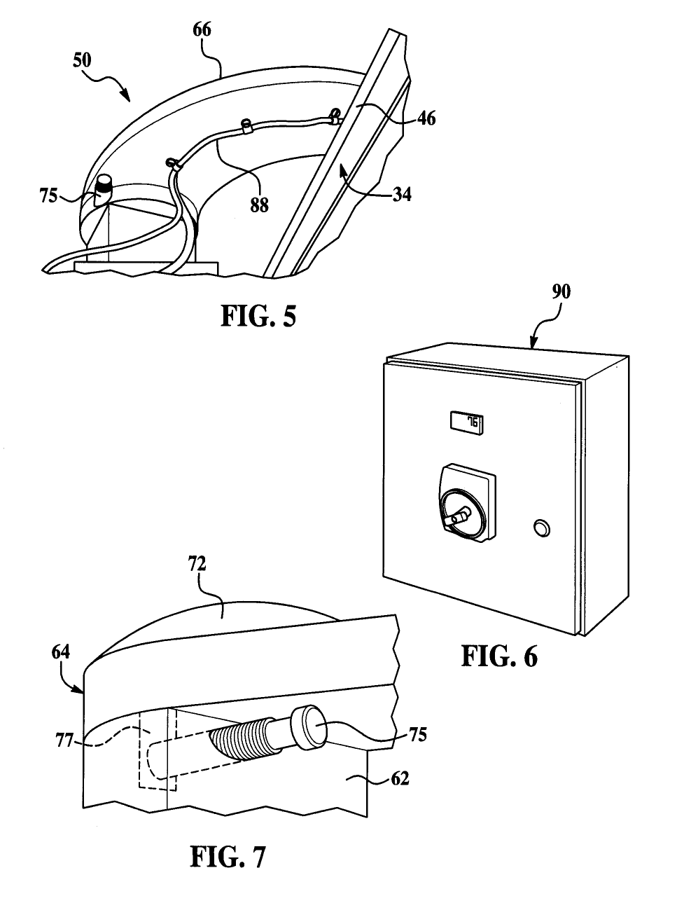

As best shown in FIG. 1, mounted pivotally to upper distal ends 62 of the adjustment member 58 of the respective assemblies 48, 50 are respective elongated arms 64, 66 biased in respective normal positions 68, 70. Arm 64 of the first cutting assembly 48 extends substantially horizontal and between a base end 72 and a distal end 74. The base end 72 engages pivotally to the distal end 62 of the support frame 52 of the first cutting assembly 48 and about pivot axis 76 that is substantially vertical. When in the normal position 68, arm 64 is spaced above and projects over the first side 44 of the transport 34 and partially over the belt 38 and beyond the centerline 36 so that the distal end 74 is spaced above the belt 38 and cantilevers outward from the support frame 52 over the transport 34 between the centerline 36 and the second side 46 of the transport 34. As best shown in FIGS. 5 and 7, the degree or amount that the arm 64 laterally traverses the transport 34 when in the normal position 60 is adjustable via a threadably adjustable stop 75 carried by the distal end 62 of the support frame 52 that is in rotational or circumferential contact with a protruding tab or circumferentially facing surface 77 of the base end 72 of the arm 64. Preferably, the adjustable stop 75 also functions as a shock absorber with the addition of a compression spring (not shown). One skilled in the art would now appreciate that the base member 56 of the support frames 52 may have a typical self-leveling feature (not shown) such that the arcuate movement of the swing arms 64, 66 is generally parallel to the transport 34.

A cutter 78 is attached to the distal end 74 of arm 64 for cutting the wrapping 22 of the wrapped product 24. The cutter 78 preferably has a disc 80 that tapers radially outward to a circumferentially extending apex 82. Preferably, the disc 80 does not rotate but is mounted releasably to and preferably beneath the distal end 74. Because the disc 80 does not rotate, the resultant increase in friction as the apex 82 slides across the wrapping 22 assists in the cutting. As the apex 82 wears, the disc 80 can be loosened and rotated with respect to the distal end 74 thereby exposing an unwarned portion of the apex 82. The necessary sharpness of the apex 82 of the disc 80 is dependent upon the wrapping material. Preferably, an electric heating element 86 mounts to the distal end 74 of the arm 64 and generally communicates with the disc 80 for heating thereof when the wrapping 22 is made of heat sensitive material such as plastic and/or shrink wrap. As best shown in FIGS. 5 and 6, electric leads or wires 88 extend from the heat element 86 and to a remote controller 90 that controls the temperature of the disc 80 and may control the speed of the transport 34.

Alternatively, the disc 80 may be mounted rotatably to the distal end 74 and about a rotation axis 84 orientated substantially parallel to the pivot axis 76. Although in this embodiment the disc 80 produces less friction, it is less likely to snag upon the wrapped product 24 when cutting and will evenly wear around the entire circumference of the apex 82.

Similar to the first assembly 48, the arm 66 of the second assembly 50 extends substantially horizontal and between a base end 92 and a distal end 94. The base end 92 engages pivotally to the distal end 62 of the support frame 52 of the second cutting assembly 50 and about pivot axis 96 that is substantially vertical. When in the normal position 70, arm 66 is spaced above and projects over the second side 46 of the transport 34 and partially over the belt 38 and beyond the centerline 36 so that the distal end 94 is spaced above the belt 38 and cantilevers outward from the support frame 52 over the transport 34 between the centerline 36 and the first side 44 of the transport 34. As best shown in FIGS. 5 and 7, the degree or amount that the arm 66 laterally traverses the transport 34 when in the normal position 70 is adjustable via a threadably adjustable stop 75 of assembly 50 carried by the distal end 62 of the support frame 52 that is in rotational or circumferential contact with a protruding tab or circumferentially facing surface 77 of the base end 92 of the arm 66.

A cutter 96 attaches to the distal end 94 of arm 66 for cutting the wrapping 22 of the wrapped product 24. The cutter 96 preferably has a disc 98 that tapers radially outward to a circumferentially extending apex 100. The disc 98 preferably mounts rigidly and releasably to the underside of the distal end 94 as does disc 80. Preferably, an electric heating element 104 mounts to the distal end 94 of the arm 66 and generally communicates with the rotating disc 98 for heating thereof when the wrapping 22 is made of heat sensitive material such as plastic and/or shrink wrap. As best shown in FIGS. 5 and 6, electric leads or wires 88 also extend from the heat element 104 and to the remote controller 90 that controls the temperature of the cutter 96. Alternatively and for the same reasons as the disc 80, disc 98 may be mounted rotatably to the distal end 94 and about a rotation axis 102 orientated substantially parallel to the pivot axis 96.

As best shown in FIG. 1, the arms 64, 66 of both respective assemblies 48, 50 are biased toward the normal positions 60, 70 via a biasing device 106. As illustrated, the devices 106 may be coiled torsion springs, as is common is retractable tape measures. Each spring 106 is orientated concentrically to the respective pivot axis 76, 96 and has a first end 108 engaged to the respective base ends 72, 92 of the arms 64, 66 and a second end 110 engaged to the distal ends 62 of the respective support frames 52. One skilled in the art would now know that any variety of known devices can be utilized to rotationally bias the arms 64, 66 including a worm drive arrangement wherein the weight of the arms alone could bias the arms toward the normal positions 60, 70. In a worm drive arrangement, however, the arms 64, 66 would rise vertically as they pivot and cut, causing the cuts along the wrapping of the wrapped product 24 to be angled with respect to a horizontal imaginary plane.

In preparation of system operation, the support frames 52 of the assemblies 48, 50 are first adjusted vertically via the lock device 61 to place the cutting discs 80, 98 at the proper distance above the belt 38 of the transport 34. Preferably the discs are aligned vertically so they cut along the tray 28 location of the wrapped product 24 as oppose to above it which could otherwise cause damage to the containers 26. Moreover, the discs 80, 98 are preferably adjusted to about the same elevation so the cut along the leading side face 39 of the wrapped product 24 is continuous. With this adjustment made, the adjustable stop 75 is then adjusted to place the discs 80, 98 is the proper lateral positions with respect to the transport 34 and when the assemblies 48, 50 are in the respective normal positions 60, 70. This lateral positioning is generally dictated by the horizontal width of the leading side face 39 of the wrapped product 24, with the desired outcome of achieving a continuous horizontal cut along the face 39.

When operating, the controller 90 of the system 20 will first elevate the temperature of the cutting discs 80, 98 through the respective heat elements 86, 104 to a predetermined temperature sufficient to cut, via melting, the preferred heat sensitive wrapping 22. Preferably, this temperature is a function of the wrapping material (e.g. shrink wrap), the wrapping thickness, and the delivery speed of the transport 34. Once the controller 90 senses that the predetermined temperature is achieved, a staging transport or conveyor 112 (see FIG. 2) first delivers the wrapped products 24 in succession to the transport 34. Preferably, the staging transport 112 delivers at a speed that is slower than the speed of the transport 34 for providing a greater separation between wrapped products 24 in preparation for cutting of the wrapping 22.

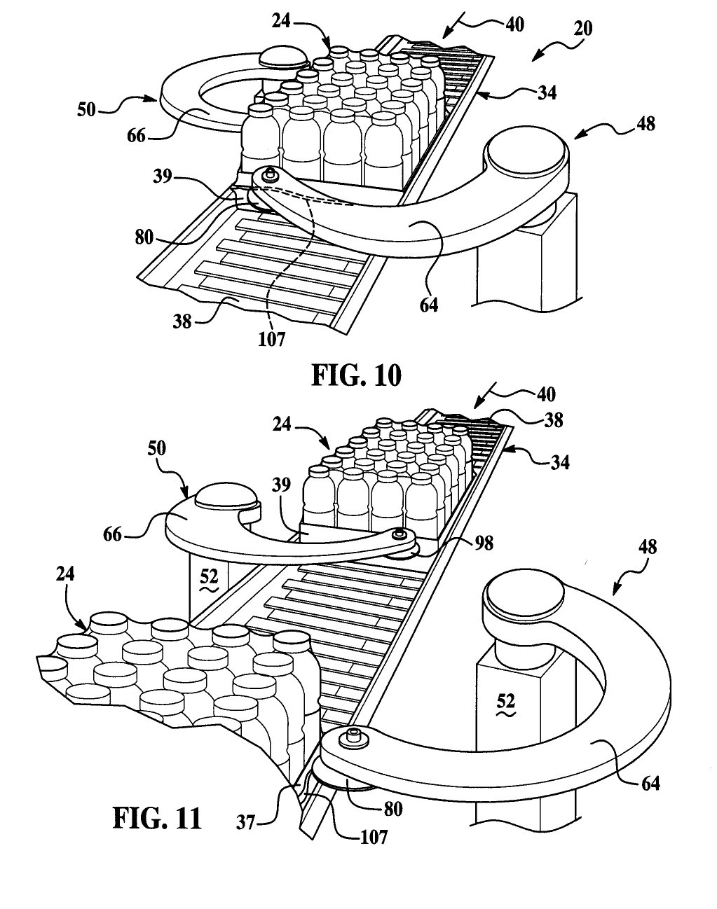

Referring to FIGS. 1, 10, and 11, when the wrapped product 24 is placed on or reaches the transport 34, the wrapping 22 at the leading face 39 of the wrapped product first abuts the heated disc 98 of the second assembly 50. Continued movement of the product 24 in the downstream direction 40 causes the disc 98 to slide across the wrapping 22 as the arm 66 pivots against the force of the biasing device 106 in a clockwise direction 116. The disc 98 slides and cuts across a majority of the face 39 creating a cut 107 and until the disc 98 embarks upon flanking side face 33 (Alternatively and as opposed to sliding, the disc 98 may rotate in a counter-clockwise direction 114 as the arm 66 pivots). At this point, the pivot arm 66 stops pivoting away from the normal position 70, but continues to exert a force against the wrapping 22 and upon the side face 33. The disc 98 continues to slide and cut along the face 33 until the wrapped product 24 moves generally past assembly 50 at which point the arm 66 pivots back to the normal position 70 in preparation for the next wrapped product 24 delivered via the transport 34.

Preferably, as the disc 98 of the cutter 96 of assembly 50 is cutting the wrapping 22 at the side face 33, the heated disc 80 of the cutter 78 of assembly 48 abuts the forward or leading face 39 generally at or along the previous cut of the wrapping 22. Continued movement of the product 24 in the downstream direction 40 causes the disc 80 to slide upon and cut across the wrapping 22 as the arm 64 pivots against the force of the respective biasing device 106 in a counter-clockwise direction 120 (alternatively, the disc 80 may rotate in a clockwise direction 118 as the arm 64 pivots). The disc 80 slides across a majority of the face 39 until the disc 80 embarks upon flanking side face 37. At this point, the pivot arm 64 stops pivoting away from the normal position 60, but continues to provide a force against the wrapping 22 and upon the side face 37. The disc 80 continues to slide and cut along the face 37 until the wrapped product 24 moves generally past assembly 48 at which point the arm 64 pivots back to the normal position 60 in preparation for the next wrapped product 24 delivered via the transport 34.

Referring back to FIG. 1, each arm 64, 66 is preferably arcuate or curved longitudinally and are concave in an upstream direction 122. This curvature allows the discs 80, 98 to move past the leading face 39, turn the respective corners of the wrapped product 24 and begin cutting the wrapping 22 on the respective flanking side faces 37, 33. The orientation of the arms 64, 66 and the continuous downstream movement 40 of the belt 38 of the transport 34 prevents the wrapping 22 on the trailing face 35 of the wrapped product 24 from being cut. Hence, the wrapping 22 is still preferably one piece as it passes the downstream assembly 48. The cut yet still one-piece wrapping 22 is advantageous for efficient removal of the wrapping 22 from the wrapped product 24.

A wrapping disposal machine 130 of the system 20 is located preferably in-line with the transport 34 and downstream of the cutting assemblies 48, 50. Preferably, the belt 38 terminates upstream of the machine 130 and a push mechanism (not shown) pushes the product 24 through the machine 130 by generally sliding the product over a horizontal surface 132 substantially co-planar to the belt 38. Located in the surface 132 of the machine 130 are a series of vacuum apertures 134. A vacuum device (not shown) is connected to the apertures 134 preferably under the transport 34. A disposal mechanism or vacuum collector 136 is disposed above the surface 132 and supported by framing 138. The disposal mechanism 136 may include a suction hose that drapes downward from the framing 138. In operation, the wrapping disposal machine 130 generally sucks the cut wrapping 22 away from the product 24 as the product continues down the transport 34.

While the forms of the invention herein disclosed constitute a presently preferred embodiment, many others are possible. Furthermore, one skilled in the art would now appreciate that the wrapped product may be of any variety of shapes including rounded, hexagonal and the like, or, that the transport 34 may not include a belt but could instead have a generally stationary, friction reducing, surface such as one supporting rollers. It is not intended herein to mention all the possible equivalent forms or ramifications of the invention. It is understood that terms used herein are merely descriptive, rather than limiting, and that various changes may be made without departing from the spirit or scope of the invention.

What is claimed is:

1. A package wrapping removal system for cutting wrapping from a wrapped product, the package wrapping removal system comprising:
a transport for moving the wrapped product in a downstream direction;
a stationary support frame defining a pivot axis;
an elongated arm pivotally mounted to the support frame about the pivot axis and having a distal end cantilevered outward from the support frame and over the transport; and
a cutter disposed on the distal end for cutting the wrapping at a leading side face of the wrapped product during the pivoting of the arm about the support frame and for cutting a flanking side face after the arm has pivoted about the leading side face.

2. The package wrapping removal system set forth in claim 1 wherein the arm projects laterally over the transport and beyond a centerline of the transport for cutting a majority of the wrapping at the leading face and wherein the arm is arcuate and concave in an upstream direction for enabling placement of the cutter from the leading side face and to the flanking side face when pivoted.

3. The package wrapping removal system set forth in claim 1 wherein the cutter has a disc carrying a continuous circumferential apex for cutting the wrapping and lying in an imaginary plane orientated perpendicular to the pivot axis.

4. The package wrapping removal system set forth in claim 3 wherein the disc is mounted rotationally to the distal end.

5. The package wrapping removal system set forth in claim 1 further comprising an electric heat element supported by the distal end for heating the cutter.

6. The package wrapping removal system set forth in claim 1 wherein the downstream direction is horizontal and the pivot axis is vertical.

7. The package wrapping removal system set forth in claim 1 wherein the arm is biased in one of a clockwise direction or a counter-clockwise direction about the pivot axis for locating the distal end over the transport.

8. The package wrapping removal system set forth in claim 7 further comprising a rotation biasing device carried between the base end and the support frame.

9. The package wrapping removal system set forth in claim 1 wherein the support frame is an adjustable telescoping column for positioning the cutter with respect to the transport.

10. The package wrapping removal system set forth in claim 1 wherein the arm is arcuate and concave in an upstream direction with respect to movement of the transport.

11. The package wrapping removal system set forth in claim 1 further comprising:
a second stationary support frame defining a second pivot axis;
a second elongated arm pivotally mounted to the second support frame about the second pivot axis and having a second distal end cantilevered outward from the second support frame and over the transport;
a second cutter disposed on the second distal end; and
wherein the arm is a first arm and the first and second arms are counter-rotational with respect to one another.

12. The package wrapping removal system set forth in claim 11 wherein:
the transport has a longitudinal first side, an opposite longitudinal second side, and a centerline extending along the downstream direction;
the first arm is cantilevered over the first side and projects beyond the centerline; and
the second arm is cantilevered over the second side and projects beyond the centerline.

13. The package wrapping removal system set forth in claim 12 wherein the first and second arms pivot in a common imaginary plane disposed parallel to the transport.

14. A counter rotational package wrapping removal system for cutting wrapping from a product as the product moves in a downstream direction, the package wrapping removal system comprising:
a transport for moving the wrapped product in the downstream direction as the wrapping is cut with the transport having a longitudinal first side, an opposite longitudinal second side and a centerline extending along the downstream direction;
a pivoting first arm cantilevered over the first side and partially traversing the transport with the first arm having a base end about which the first arm pivots and an opposite distal end disposed between the centerline and the second side when the first arm is pivotally biased in a first normal position;
a pivoting second arm cantilevered over the second side and partially traversing the transport with the second arm having a base end about which the second arm pivots and an opposite distal end disposed between the centerline and the first side when the second arm is pivotally biased in a second normal position; and
first and second cutters carried by the respective distal ends of the first and second arms for cutting the wrapping of the product.

15. The counter rotational package wrapping removal system set forth in claim 14 wherein the first arm is pivotally biased in a clockwise direction and the second arm is pivotally biased in a counter-clockwise direction.

16. The counter rotational package wrapping removal system set forth in claim 15 wherein the first arm is located downstream of the second arm with respect to the transport.

17. The counter rotational package wrapping removal system set forth in claim 14 further comprising a heat element for each of the respective first and second cutters and carried by the respective distal ends of the first and second arms.

18. The counter rotational package wrapping removal system set forth in claim 14 further comprising:
a first support frame for pivotally supporting the first arm;
a second support frame for pivotally supporting the second arm;
a first biasing device carried between the first support frame and the base end of the first arm for biasing the first arm in the first normal position; and
a second biasing device carried between the second support frame and the base end of the second arm for biasing the second arm in the second normal position.

19. A method of removing wrapping from a wrapped product with the wrapped product having a leading face and flanking side faces, and the system having a transport and first and second arms with each of the arms carrying a cutter, the method comprising the steps of:
positioning the wrapped product on the transport with the leading face of the product facing downstream with respect to movement of the transport;
contacting the leading face with the first cutter of the first arm;
pivoting the first arm to move the cutter of the first arm along the leading face;
cutting the wrapping on the leading face;
contacting a flanking first side face with the first cutter;
cutting the wrapping by the first cutter along the flanking first side face;
contacting the leading face with the second cutter of the second arm with the wrapping at the leading face;
pivoting the second arm to move the second cutter along the leading face;
cutting the wrapping on the leading face;
contacting an opposite flanking second side face with the second cutter;
cutting the wrapping by the second cutter along the flanking second side face.

20. The method set forth in claim 19 further comprising the step of heating the first and second cutters for melting the wrapping when cutting.

21. The method set forth in claim 19 further comprising the step of the first arm automatically pivoting back to a first normal position when the first flanking side face moves downstream of the first cutter.

22. The method set forth in claim 21 further comprising the step of the second arm automatically pivoting back to the second normal position when the second flanking side face moves downstream of the second cutter.
